(19) United States
(12) Patent Application Publication
(10) Pub. No.: US 2024/0336805 A1
(43) Pub. Date: Oct. 10, 2024

(54) NEW TWO-COMPONENT COATING SYSTEMS CONTAINING POLYASPARTIC ACID ESTERS

(71) Applicant: Covestro Deutschland AG, Leverkusen (DE)

(72) Inventors: Erkan Durgut, Bochum (DE); Dorota Greszta-Franz, Solingen (DE); Matthias Wintermantel, Hürth (DE)

(21) Appl. No.: 18/294,674

(22) PCT Filed: Aug. 12, 2022
(86) PCT No.: PCT/EP2022/072667

§ 371 Date: Feb. 2, 2024

(30) Foreign Application Priority Data
Aug. 17, 2021 (EP) 21191597.0

(51) Int. Cl. C09D 175/02; C09D 175/04

(52) U.S. Cl. CPC C09D 175/02; C09D 175/04

(57) ABSTRACT

The present invention relates to two-component coating systems containing polyaspartic acid esters with only small amounts of fumaric acid dialkyl esters, to a method for preparing same and their use for producing coatings for use in construction and wind energy. An example for the use of these systems is for coating roofs, for coating floorings and for coating rotor blades of wind turbines, or the leading edges of their rotor blades.

The present invention relates to two-component coating systems comprising polyaspartic esters containing only small amounts of dialkyl fumarates, to a process for the production thereof, and to the use thereof for producing coatings, in particular for the construction and wind energy sectors. Examples include use for roof coating, for floor coating, and for coating rotor blades in wind turbines and the leading edges thereof.

Two-component (2K) coating compositions comprising, as binder, a polyisocyanate component in combination with a reactive component that is reactive toward isocyanate groups, in particular a polyhydroxy component, have long been known. They are suitable for producing high-quality coatings that can be tailored to make them hard, elastic, resistant to abrasion and solvents and, above all, weather-resistant.

Within this 2K polyurethane coating technology, certain secondary polyamines containing ester groups have become established in recent years, the so-called polyaspartic esters or polyaspartates, which, in combination with paint polyisocyanates, are particularly suitable as binders in low-solvent or solvent-free (high-solids) coating compositions and allow rapid curing of the coatings at low temperatures.

The use in 2K coating compositions of polyaspartic esters either alone or in a mixture with further components reactive toward isocyanate groups is described for example in EP0403921, EP0639628, EP0667362, EP0689881, U.S. Pat. No. 5,214,086, EP0699696, EP0596360, EP0893458, DE19701835, EP0470461, WO15130501, WO15130502 and U.S. Pat. No. 5,243,012.

The preparation of amino-functional aspartic esters is known per se. The synthesis is achieved via addition of primary polyamines and/or polyetheramines to an activated carbon-carbon double bond of vinylogous carbonyl compounds, as present for example in maleic or fumaric esters, which is adequately described in the literature (Houben-Weyl, Meth. d. Org. Chemie vol. 11/1, 272 (1957), Usp. Khim. 1969, 38, 1933). If only one amino group of the polyamine/polyetheramine has reacted with the double bond of the vinylogous carbonyl compounds, this reaction can result in the formation, as a side product, of a polyaspartic ester having primary amino groups. In the commercially available polyaspartic esters, maleic ester is used as the vinylogous carbonyl compound. During preparation of a polyaspartic ester based on maleic esters, a retro-Michael addition can occur as a further undesired side reaction in which elimination of the polyamine results in the formation of dialkyl fumarate as a minor component. A typical production process for a polyaspartic ester therefore requires a storage time of 4-6 weeks once most of the reactants have reacted with each other. During this time, the product undergoes so-called maturation, which is manifested by stabilization of the viscosity. Because conversion continues to increase during this time, the dialkyl fumarate content falls too. This storage over several weeks incurs significant logistics costs during production. Although the product is not shipped to the customer until the end of the storage period, it invariably still contains substantial amounts of dialkyl fumarate, which can cause severe sensitization. After maturation, the polyaspartic esters thus prepared typically still contain residual amounts of fumaric esters ranging from 3 to 20 percent by weight. Although storage for longer periods would further reduce the content of fumaric esters to approx. 1 percent by weight, this would be to the detriment of other properties, such as color or viscosity.

WO2019/057626A1 and WO2019/057627A1 disclose the preparation of polyaspartic esters having a significantly reduced dialkyl fumarate content by means of a special distillation process.

As already mentioned above, polyaspartic esters can be used for producing low-solvent or solvent-free (high-solids) coating compositions. This is a key aspect in relation to occupational hygiene, especially when working e.g. in confined spaces, for example when coating floors. Among polyaspartic esters, a distinction can be made between those based on (ether group-free) polyamines and those based on polyetheramines. Polyaspartic esters based on polyetheramines have significantly lower viscosity than polyaspartic esters based on polyamines. Polyetheramine-based polyaspartic esters can therefore be used as thinners for polyamine-based polyaspartic esters. This allows solvents to be reduced in amount or dispensed with altogether. The use of corresponding polyaspartic acid mixtures for producing coating compositions for floors is accordingly commonplace (for example specialist article in Farbe und Lack, November 2017, pages 30 to 35). However, coatings produced by coating with corresponding prior art coating compositions have up to now shown inadequate tensile strength and tear propagation resistance when exposed to relatively high mechanical stresses, as is the case with industrial floors, for example.

The object of the present invention was to provide a coating composition based on polyaspartic ester mixtures for producing coatings having improved mechanical properties, such as improved tensile strength and tear propagation resistance.

It was surprisingly found that this object may be achieved by coating compositions based on polyaspartic ester mixtures having a greatly reduced dialkyl fumarate content. The dialkyl fumarate content in the polyaspartic ester-containing component is according to the invention from 0.02% to 0.75% by weight, based on the total weight of the polyaspartic ester-containing component, and can be reduced to these values by a special distillation process.

The abovementioned WO2019/057626A1 describes not just the production of polyaspartic esters having a significantly reduced dialkyl fumarate content but also the use thereof in coating compositions. The synthesis of polyamine-based and polyetheramine-based polyaspartic esters is demonstrated. However, the use specifically of a mixture of both classes of compounds for producing coating compositions is not disclosed, neither was there any mention that specifically a greatly reduced content of dialkyl fumarates in these mixtures results in coatings having very high tensile strength and tear propagation resistance.

WO2020/169700A1 and WO2020/169701A1 also describe coating compositions based on polyaspartic esters having a reduced dialkyl fumarate content. The use of polyamine-based and polyetheramine-based polyaspartic esters is described here too, but not the use specifically of mixtures thereof. Here too, there is no pointer to the relationship between a low dialkyl fumarate content in such mixtures and the derived effect of significantly improved tensile strength and tear propagation resistance in the coatings obtainable using such mixtures.

The present invention provides two-component coating compositions (2K coating compositions) comprising
a) at least one polyaspartic ester-containing component A,
b) at least one polyisocyanate component B,
c) optionally one or more components C that are different from A and are reactive toward isocyanate groups, and
d) optionally auxiliaries and additives D,
wherein component A corresponds to compositions comprising
   A1) one or more polyaspartic esters of the general formula (I)

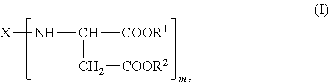

in which
X is an m-valent organic radical, optionally containing one or more heteroatoms, as can be obtained by removing the primary amino groups from a corresponding polyamine that has (cyclo)aliphatically or araliphatically attached primary amino groups and is in the molecular weight range from 60 to 6000 g/mol, and which may contain further functional groups reactive toward isocyanate groups and/or further functional groups inert at temperatures of up to 100° C.,
   R¹ and R² are identical or different organic radicals each having 1 to 18 carbon atoms,
   m is an integer >1, preferably 2,
and
optionally one or more polyaspartic esters having a primary amino group that are of the general formula (II)

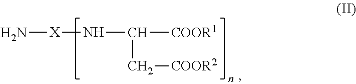

in which
n is m-1 and
m, X, and the radicals R¹ and R² are as defined above,
   and
   A2) one or more polyaspartic esters of the general formula (III)

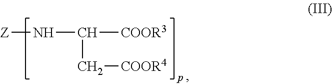

in which
Z is a p-valent organic radical, optionally containing one or more heteroatoms, as can be obtained by removing the primary amino groups from a corresponding polyether polyamine that has aliphatically attached primary amino groups and is in the molecular weight range from 200 to 2000 g/mol, and which may contain further functional groups reactive toward isocyanate groups and/or further functional groups inert at temperatures of up to 100° C.,
R³ and R⁴ are identical or different organic radicals each having 1 to 18 carbon atoms,
p is an integer >1, preferably 2 or 3,
   wherein component A2 is present in a proportion of from ≥1% to ≤80% by weight based on the total weight of components A1 and A2, and
   wherein dialkyl fumarates are present in component A in an amount of from ≥0.02% to ≤0.75% by weight based on the total weight of component A.

The dialkyl fumarate content is determined as described below in the experimental section.

It should at this point be made clear that, in the context of the present invention, polyether polyamines are to be considered excluded from the polyamine class of compounds.

### Component A1

Polyaspartic ester-containing components A are preferably compositions comprising as component A1 one or more polyaspartic esters of the general formulas (I) and optionally (II) in which R¹ and R² are identical or different alkyl radicals each having 1 to 18 carbon atoms, preferably identical or different alkyl radicals each having 1 to 8 carbon atoms, and most preferably in each case alkyl radicals such as methyl, ethyl, propyl, isopropyl, butyl or isobutyl radicals. Most preferred is ethyl.

Polyaspartic ester-containing components A are compositions comprising as component A1 one or more polyaspartic esters of the general formulas (I) and optionally (II), in which X represents organic radicals obtained by removing the primary amino groups from a corresponding polyamine having primary amino groups, selected from the following group: all known polyamines having primary amino groups that correspond to the general formula (IV)

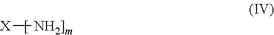

where
X is an m-valent organic radical, optionally containing one or more heteroatoms, as can be obtained by removing the primary amino groups from a polyamine that has (cyclo)aliphatically or araliphatically attached primary amino groups and is in the molecular weight range from 60 to 6000 g/mol, and which may contain further functional groups reactive toward isocyanate groups and/or further functional groups inert at temperatures of up to 100° C. and
m is an integer >1, preferably 2.

Examples include the following compounds: ethylenediamine, 1,2-diaminopropane, 1,4-diaminobutane, 1,5-diaminopentane, 2,5-diamino-2,5-dimethylhexane, 1,5-diamino-2-methylpentane (Dytek® A, from Invista), 1,6-diaminohexane, 2,2,4- and/or 2,4,4-trimethyl-1,6-diaminohexane, 1,11-diaminoundecane, 1,12-diaminododecane or triaminononane. Also employable are aliphatic polycyclic polyamines such as tricyclodecanebismethylamine (TCD diamine) or bis(aminomethyl)norbornanes, amino-functional siloxanes, for example diaminopropylsiloxane G10 DAS (from Momentive), oleoalkyl-based amines, for example Fentamine from Solvay, and dimeric fatty acid diamines such as Priamine from Croda.

Preferably, polyaspartic ester-containing components A are compositions comprising as component A1 one or more polyaspartic esters of the general formulas (I) and optionally (II), in which X represents organic radicals obtained by removing the primary amino groups from one of the polyamines of the general formula (IV) in which m=2 and X is a cyclic hydrocarbon radical containing at least one cyclic carbon ring. Examples of diamines that may be used with particular preference are 1-amino-3,3,5-trimethyl-5-aminomethylcyclohexane (IPDA), 2,4- and/or 2,6-hexahydrotolylenediamine (H6-TDA), isopropyl-2,4-diaminocyclohexane and/or isopropyl-2,6-diaminocyclohexane, 1,3-bis(aminomethyl)-cyclohexane, 2,4′-, and/or 4,4′-diaminodicyclohexylmethane, 3,3′-dimethyl-4,4′-diaminodicyclohexyl-methane (Laromin® 260, BASF AG), the isomeric diaminodicyclohexylmethanes substituted in the ring with a methyl group (=C-monomethyl-diaminodicyclohexylmethanes), 3(4)-aminomethyl-1-methylcyclohexylamine (AMCA) and also araliphatic diamines such as 1,3-bis(aminomethyl)benzene or m-xylylenediamine.

Likewise preferably, polyaspartic ester-containing components A are compositions comprising as component A1 one or more polyaspartic esters of the general formulas (I) and optionally (II), in which X represents organic radicals obtained by removing the primary amino groups from one of the polyamines of the general formula (IV) selected from the group: 1,2-diaminopropane, 1,4-diaminobutane, 1,6-diaminohexane, 1,5-diamino-2-methylpentane, 2,5-diamino-2,5-dimethylhexane, 2,2,4- and/or 2,4,4-trimethyl-1,6-diaminohexane, 1,11-diaminoundecane, 1,12-diaminododecane, 1-amino-3,3,5-trimethyl-5-aminomethylcyclohexane, 2,4- and/or 2,6-hexahydrotolylenediamine, 1,5-diaminopentane, 2,4′- and/or 4,4′-diaminodicyclohexylmethane or 3,3′-dimethyl-4,4′-diaminodicyclohexylmethane. Particular preference is given to 3,3′-dimethyl-4,4′-diaminodicyclohexylmethane, 1,5-diaminopentane, 2,4′- and/or 4,4′-diaminodicyclohexylmethane, 1,5-diamino-2-methylpentane, and very particular preference to using 2,4′- and/or 4,4′-diaminodicyclohexylmethane.

More preferably, polyaspartic ester-containing components A are compositions comprising as component A1 one or more polyaspartic esters of the general formulas (I) and optionally (II), in which X represents organic radicals obtained by removing the primary amino groups from one of the polyamines of the general formula (IV) selected from the group: 1,2-diaminopropane, 1,4-diaminobutane, 1,5-diaminopentane, 1,6-diaminohexane, 1,5-diamino-2-methylpentane, 2,5-diamino-2,5-dimethylhexane, 2,2,4- and/or 2,4,4-trimethyl-1,6-diaminohexane, 1,11-diaminoundecane, 1,12-diaminododecane, 1-amino-3,3,5-trimethyl-5-aminomethylcyclohexane, 2,4- and/or 2,6-hexahydrotolylenediamine, 2,4′- and/or 4,4′-diaminodicyclohexylmethane or 3,3′-dimethyl-4,4′-diaminodicyclohexylmethane.

Most preferably, polyaspartic ester-containing components A are compositions comprising as component A1 one or more polyaspartic esters of the general formulas (I) and optionally (II), in which X represents organic radicals obtained by removing the primary amino groups from one of the polyamines of the general formula (IV) selected from the group: 3,3′-dimethyl-4,4′-diaminodicyclohexylmethane, 2,4′- and/or 4,4′-diaminodicyclohexylmethane, and 1 5-diamino-2-methylpentane.

Index m is an integer >1 and preferably 2.

### Component A2

Polyaspartic ester-containing components A are preferably compositions comprising as component A2 one or more polyaspartic esters of the general formula (III) in which R³ and R⁴ are identical or different alkyl radicals each having 1 to 18 carbon atoms, preferably identical or different alkyl radicals each having 1 to 8 carbon atoms, and most preferably in each case alkyl radicals such as methyl, ethyl, propyl, isopropyl, butyl or isobutyl radicals. Most preferred is ethyl.

Polyaspartic ester-containing components A are compositions comprising as component A2 one or more polyaspartic esters of the general formula (III), in which Z represents organic radicals obtained by removing the primary amino groups from a corresponding polyether polyamine having primary amino groups selected from the following group: all known polyether polyamines having primary amino groups that correspond to the general formula (V)

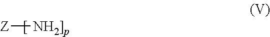

where
Z is a p-valent organic radical, optionally containing one or more heteroatoms, as can be obtained by removing the primary amino groups from a corresponding polyether polyamine that has aliphatically attached primary amino groups and is in the molecular weight range from 200 to 2000 g/mol, and which may contain further functional groups reactive toward isocyanate groups and/or further functional groups inert at temperatures of up to 100° C., and
p is an integer >1, preferably 2 or 3.

Examples include the following compounds: low-molecular-weight polyether polyamines, such as 4,9-dioxadodecane-1,12-diamine and 4,7,10-trioxatridecane-1,13-diamine, and relatively high-molecular-weight polyether polyamines having aliphatically attached primary amino groups. The latter, i.e. relatively high-molecular-weight polyether polyamines, include for example compounds having at least one repeat unit of the following general formula (VI):

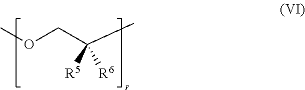

where r is an integer from 2 to 35 and R⁵ and R⁶ are each independently hydrogen or a C₁ to C₄ alkyl radical.

These include for example polyether polyamines based on ethylene oxide, propylene oxide or a mixture of ethylene oxide and propylene oxide and having an amino group functionality of 2 or 3. Preferred amino-containing polyethers of this type correspond to the following general formulas (VII) to (X):

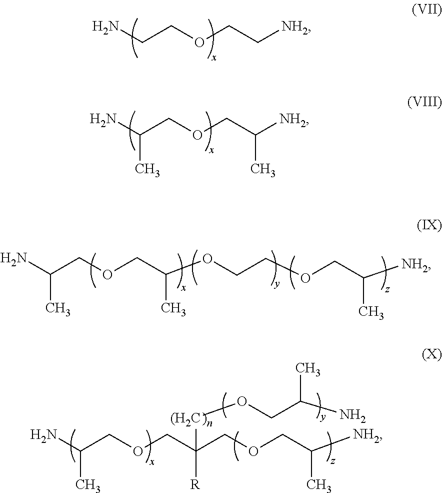

where x is a number from 0 to 10, y is a number from 0 to 40, and z is a number from 0 to 10. Examples of such polyether polyamines are the products obtainable under the Jeffamine® name from Huntsman Corporation or corresponding products sold by BASF SE under the Baxxodur name. Particular preference is given to using polyether polyamines corresponding to
i) the formula (VIII)

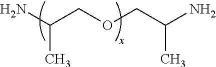

where x is a number from 2 to 8, especially 2.5 to 6.1. These polyether polyamines correspond for example to polyether polyamines of the Jeffamine® D series from Huntsman Corporation, in particular Jeffamine® D-230 and Jeffamine® D-400.
ii) the formula (IX)

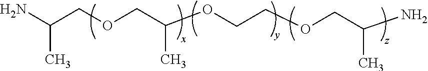

where y is a number from 5 to 40 and the sum x+z is a number from 3 to 8. These polyether polyamines correspond for example to polyether polyamines of the Jeffamine® ED series from Huntsman Corporation. In particular, y is about 9.0 and x+z is about 3.6, or y is about 12.5 and x+z is about 6.0 (corresponding for example to Jeffamine® ED-600 and Jeffamine® ED-900 respectively).
iii) the formula (X)

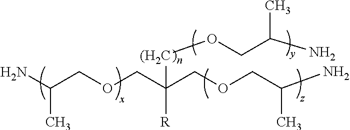

where R=hydrogen, CH₃ or C₂H₅, n=0, 1 or 2, and x+y+z=a number from 3 to 100. These polyether polyamines correspond for example to polyether polyamines of the Jeffamine® T series. In particular, R=C₂H₅, n=1, and x+y+z=5 to 6 (corresponding for example to Jeffamine® T-403).

Very particular preference is given to using polyether polyamines of the formula (VIII), where x is a number from 2 to 8, especially 2.5 to 6.1 (subpoint i) above).

Polyaspartic ester-containing components A are compositions comprising a component A1 and a component A2, component A2 being present in a proportion of from ≥1% to ≤80% by weight, preferably ≥10% to ≤80% by weight, more preferably ≥25% to ≤55% by weight, most preferably ≥30% to ≤50% by weight, based on the total weight of components A1 and A2.

Polyaspartic ester-containing components A are compositions comprising one or more polyaspartic esters of the general formula (I) and optionally formula (II), and also of the general formula (III), having a content of dialkyl fumarates of ≥0.02% to ≤0.75% by weight, preferably ≥0.02% to ≤0.27% by weight, more preferably ≥0.02% to ≤0.25% by weight, even more preferably ≥0.02% to ≤0.1% by weight, most preferably ≥0.01% to ≤0.05% by weight, based on the total weight of component A.

Preferably, polyaspartic ester-containing components A are compositions wherein component A2 is present in a proportion of ≥1% to ≤80% by weight, preferably ≥10% to ≤80% by weight, more preferably ≥25% to ≤55% by weight, most preferably ≥30% to ≤50% by weight, based on the total weight of components A1 and A2, and dialkyl fumarates are present in a proportion of ≥0.02% to ≤0.75% by weight based on the total weight of component A.

More preferably, polyaspartic ester-containing components A are compositions wherein component A2 is present in a proportion of ≥1% to ≤80% by weight, preferably ≥10% to ≤80% by weight, more preferably ≥25% to ≤55% by weight, most preferably ≥30% to ≤50% by weight, based on the total weight of components A1 and A2, and dialkyl fumarates are present in a proportion of ≥0.02% to ≤0.27% by weight based on the total weight of component A.

Even more preferably, polyaspartic ester-containing components A are compositions wherein component A2 is present in a proportion of ≥1% to ≤80% by weight, preferably ≥10% to ≤80% by weight, more preferably ≥25% to ≤55% by weight, most preferably ≥30% to ≤50% by weight, based on the total weight of components A1 and A2, and dialkyl fumarates are present in a proportion of ≥0.02% to ≤0.25% by weight based on the total weight of component A.

Further preferably, polyaspartic ester-containing components A are compositions wherein component A2 is present in a content of ≥1% to ≤80% by weight, preferably ≥10% to ≤80% by weight, more preferably ≥25% to ≤55% by weight, most preferably ≥30% to ≤50% by weight, based on the total weight of components A1 and A2, and dialkyl fumarates are present in a content of ≥0.02% to ≤0.1% by weight based on the total weight of component A.

Most preferably, polyaspartic ester-containing components A are compositions wherein component A2 is present in a proportion of ≥1% to ≤80% by weight, preferably ≥10% to ≤80% by weight, more preferably >25% to ≤55% by weight, most preferably ≥30% to ≤50% by weight, based on the total weight of components A1 and A2, and dialkyl fumarates are present in a proportion of ≥0.02% to ≤0.05% by weight based on the total weight of component A.

Where the polyaspartic ester-containing component A1 comprises one or more polyaspartic esters of the general formula (II), these are present in a proportion of >0%, preferably ≥0.1%, more preferably ≥1%, most preferably ≥4%, and preferably ≤20%, more preferably ≤15%, of the area by GC (measured as area % in the gas chromatogram), wherein the sum of the areas by GC of compounds of the two general formulas (I) and (II) is 100%. Any combination of the specified upper and lower limits is possible. All possible combinations are considered disclosed.

Polyaspartic ester-containing components A are preferably compositions comprising one or more polyaspartic esters of the general formula (I) and optionally formula (II), and also of the general formula (III), wherein the esters have a platinum-cobalt color index of ≤200, more preferably ≤100. The platinum-cobalt color index is measured in accordance with DIN EN ISO 6271:2016-05.

Polyaspartic ester-containing components A1 comprising one or more polyaspartic esters of the general formula (I) and formula (II) can be produced by the following process:

Reaction of polyamines of the general formula (IV).

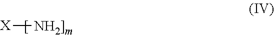

where X
is an m-valent organic radical, optionally containing one or more heteroatoms, as can be obtained by removing the primary amino groups from a polyamine that has (cyclo)aliphatically or araliphatically attached primary amino groups and is in the molecular weight range from 60 to 6000 g/mol, and which may contain further functional groups reactive toward isocyanate groups and/or further functional groups inert at temperatures of up to 100° C.
m is an integer >1, preferably 2,
   with compounds of the general formula (XI)

R¹OOC—CH═CH—COOR² (XI),

where R¹ and R²
are identical or different organic radicals, preferably identical or different alkyl radicals each having 1 to 18 carbon atoms, more preferably identical or different alkyl radicals each having 1 to 8 carbon atoms, very particularly preferably in each case alkyl radicals such as methyl, ethyl, propyl, isopropyl, butyl or isobutyl radicals and most preferably ethyl,
   and removal by distillation of the unreacted fraction of the compound of the general formula (XI).

Examples of compounds of the general formula (XI) include the following compounds: dimethyl maleate, diethyl maleate, di-n-propyl or diisopropyl maleate, di-n-butyl maleate, di-2-ethylhexyl maleate or the corresponding fumaric esters. Very particular preference is given to diethyl maleate.

For examples of compounds of the general formula (IV) and preferred ranges thereof, reference should be made to the statements above.

The process described above for producing polyaspartic ester-containing components A1 comprising one or more polyaspartic esters of the general formula (I) and formula (II) is preferably carried out in two steps. In the first step, the compounds of the general formula (IV) and (XI) are reacted at temperatures between 0° C. and 100° C., preferably 20° to 80° C., and more preferably 20° to 60° C., in a ratio of equivalents of primary amino groups in the compounds of the general formula (IV) to C═C double bond equivalents in the compounds of the general formula (XI) of 1:1.2 to 1.2:1, but preferably 1:1.05 to 1.05:1, more preferably 1:1, until the residual content of compounds of the general formula (XI) is from ≥2 to ≤15 percent by weight, preferably from ≥3 to ≤10 percent by weight.

In the second step, the unreacted fraction of the compounds of the general formula (XI) is removed by distillation.

Polyaspartic ester-containing components A1 that comprise only polyaspartic esters of the general formula (I), but not of the formula (II), can be prepared in analogous manner, but employing a large excess of compounds of the general formula (XI), i.e. in a ratio of equivalents of primary amino groups in the compounds of the general formula (IV) to C═C double bond equivalents in the compounds of the general formula (XI) of 1:10, preferably 1:5, more preferably 1:2.

Suitable conditions during the distillation are a pressure range between 0.01 and 2 mbar and a temperature in the bottom outflow on exiting the distillation apparatus of ≤170° C. and ≥the temperature resulting from the following formula (1):

$$T ( bottom outflow ) = 27 \times ln ( p ) + 150 \qquad ( 1 )$$

where T (bottom outflow) is the temperature of the bottom outflow in ° C. and
p is the pressure in the distillation apparatus in mbar.

Maintaining this pressure range ensures not only that moderate temperatures in the bottom outflow are sufficient for depletion of the dialkyl fumarate content to the desired extent, but that the process remains usable on an industrial scale. At lower pressure, the gas density becomes too low and the necessary apparatus consequently so large that the process becomes economically disadvantageous.

The temperature of the bottom outflow is preferably ≤170° C., but at least 20 K above the temperature resulting from formula (1); more preferably it is between 20 K and 40 K above the temperature resulting from formula (1), but not higher than 170° C.

Polyaspartic ester-containing components A2 may be produced in analogous manner to the polyaspartic ester-containing components A1 by

reaction of polyamines of the general formula (V),

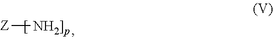

where Z
is a p-valent organic radical, optionally containing one or more heteroatoms, as can be obtained by removing the primary amino groups from a corresponding polyether polyamine that has aliphatically attached primary amino groups and is in the molecular weight range from 200 to 2000 g/mol, and which may contain further functional groups reactive toward isocyanate groups and/or further functional groups inert at temperatures of up to 100° C., and
p is an integer >1, preferably 2 or 3,
   with compounds of the general formula (XII)

R³OOC—CH═CH—COOR⁴ (XII),

where
R³ and R⁴ are identical or different alkyl radicals each having 1 to 18 carbon atoms, preferably identical or different alkyl radicals each having 1 to 8 carbon atoms, and very particularly preferably in each case alkyl radicals such as methyl, ethyl, propyl, isopropyl, butyl or isobutyl radicals, and most preferably ethyl,
   and removal by distillation of the unreacted fraction of the compound of the general formula (XII).

Examples of compounds of the general formula (XII) include the following compounds: dimethyl maleate, diethyl maleate, di-n-propyl or diisopropyl maleate, di-n-butyl maleate, di-2-ethylhexyl maleate or the corresponding fumaric esters. Very particular preference is given to diethyl maleate.

For examples of compounds of the general formula (V) and preferred ranges thereof, reference should be made to the statements above.

The process described above for producing polyaspartic ester-containing components A2 comprising one or more polyaspartic esters of the general formula (III) is preferably carried out in two steps. In the first step, the compounds of the general formula (V) and (XII) are reacted at temperatures between 0° C. and 100° C., preferably 20° to 80° C., and more preferably 20° to 60° C., in a ratio of equivalents of primary amino groups in the compounds of the general formula (V) to C═C double bond equivalents in the compounds of the general formula (XII) of 1:10, preferably 1:5, more preferably 1:2, until the residual content of compounds of the general formula (XII) is from 2 to 15 percent by weight, preferably from 3 to 10 percent by weight.

In the second step, the unreacted fraction of the compounds of the general formula (XII) is removed by distillation. With regard to the distillation conditions, what was said above in relation to the production of polyaspartic ester-containing components A1 applies by analogy.

Component A can be obtained by mixing the individually synthesized components A1 and A2.

In an alternative process, component A can also be produced by first reacting a mixture of polyamines of the general formula (IV) and polyether polyamines of the general formula (V) with compounds of the general formula (XI) and, in a second step, removing by distillation the unreacted fraction of the compound of the general formula (XI), wherein, for X, m, Z, p, R¹, and R², the above description and above preferred ranges apply and in addition: R¹=R³ and R²=R⁴.

The mixing ratio of the compounds of the general formula (IV) and (V) in the first step is here preferably ≥1% to ≤80% by weight, preferably ≥10% to ≤80% by weight, more preferably ≥25% to ≤55% by weight, most preferably ≥30% to ≤50% by weight, of the compound of the general formula (V) based on the total weight of the compounds of the general formula (IV) and (V). The mixture is preferably reacted at temperatures between 0° C. and 100° C., preferably 20° to 80° C., and more preferably 20° to 60° C., in a ratio of equivalents of primary amino groups in the compounds of the general formula (IV) and (V) (sum total) to C═C double bond equivalents in the compounds of the general formula (XI) of 1:1.2 to 1.2:1, but preferably 1:1.05 to 1.05:1, more preferably 1:1, until the residual content of compounds of the general formula (XI) is from 2 to 15 percent by weight, preferably from 3 to 10 percent by weight.

If component A is to be free of compounds of the general formula (II), then a ratio of equivalents of primary amino groups in the compounds of the general formula (IV) and (V) (sum total) to C═C double-bond equivalents in the compounds of the general formula (XI) of 1:10, preferably 1:5, more preferably 1:2, is employed.

With regard to the distillation conditions in the second step, what was said previously in the description of the production of the individual components A1 and A2 applies by analogy.

The two-component coating compositions of the invention comprise at least one polyisocyanate component B.

Suitable polyisocyanate components B are organic polyisocyanates having an average NCO functionality of at least 2 and a molecular weight of at least 140 g/mol. Particularly well suited are unmodified organic polyisocyanates in the molecular weight range from 140 to 300 g/mol, paint polyisocyanates in the molecular weight range from 300 to 1000 g/mol, and NCO prepolymers having urethane, urea and/or allophanate groups and a molecular weight above 400 g/mol, or mixtures thereof.

For the purposes of the invention, the term “paint polyisocyanates” is understood as meaning compounds or mixtures of compounds that can be obtained from simple polyisocyanates by an oligomerization reaction known per se. Examples of suitable oligomerization reactions are carbodiimidization, dimerization, trimerization, biuretization, urea formation, urethanization, allophanatization and/or cyclization with formation of oxadiazine structures. Oligomerization may comprise more than one of the abovementioned reactions performed simultaneously or in succession.

The “paint polyisocyanates” are preferably biuret polyisocyanates, polyisocyanates containing isocyanurate groups, polyisocyanate mixtures containing isocyanurate and uretdione groups, polyisocyanates containing urethane and/or allophanate groups, or polyisocyanate mixtures containing isocyanurate and/or allophanate groups based on simple organic polyisocyanates.

Likewise suitable as polyisocyanate component B are prepolymers containing isocyanate groups that are known per se and based firstly on simple organic polyisocyanates and/or paint polyisocyanates and secondly on organic polyhydroxy compounds having a molecular weight of above 300 g/mol.

Whereas the paint polyisocyanates containing urethane groups are derivatives of low-molecular-weight polyols in the molecular weight range from 62 to 300 g/mol, suitable polyols being for example ethylene glycol, propylene glycol, trimethylolpropane, glycerol or mixtures of these alcohols, the prepolymers containing isocyanate groups are produced using polyhydroxy compounds having a molecular weight of above 300 g/mol, preferably above 400 g/mol, more preferably between 400 and 8000 g/mol. Such polyhydroxy compounds are in particular those having 2 to 6, preferably 2 to 3, hydroxyl groups per molecule and selected from the group consisting of ether, ester, thioether, carbonate, and polyacrylate polyols and mixtures of such polyols.

For the production of the prepolymers containing isocyanate groups, the mentioned higher-molecular-weight polyols may also be used in the form of mixtures with the mentioned low-molecular-weight polyols, giving rise directly to mixtures of low-molecular-weight paint polyisocyanates containing urethane groups and higher-molecular-weight NCO prepolymers that are likewise suitable as polyisocyanate component b) of the invention.

For the production of the prepolymers containing isocyanate groups or mixtures thereof with paint polyisocyanates, simple organic polyisocyanates of the type mentioned by way of example below or paint polyisocyanates are reacted with higher-molecular-weight hydroxy compounds or mixtures thereof with low-molecular-weight polyhydroxy compounds of the type mentioned by way of example, while maintaining an NCO/OH equivalents ratio of from 1.1:1 to 40:1, preferably 2:1 to 25:1, resulting in urethane and/or allophanate formation. If using an excess of a distillable simple organic polyisocyanate, this may optionally be removed after the reaction by distillation, resulting in the presence of monomer-free NCO prepolymers containing isocyanate groups that may likewise be used as polyisocyanate component b).

Examples of suitable simple organic polyisocyanates are 1,4-diisocyanatobutane, 1,5-diisocyanatopentane, 1,6-diisocyanatohexane (HDI), 1,5-diisocyanato-2,2-dimethylpentane, 2,2,4- and 2,4,4-trimethyl-1,6-diisocyanatohexane, tetramethylxylylene diisocyanate (TMXDI) 1-isocyanato-3,3,5-trimethyl-5-isocyanatomethylcyclohexane (isophorone diisocyanate, IPDI), 1-isocyanato-1-methyl-4(3)-isocyanatomethylcyclohexane, dicyclohexylmethane 2,4′-diisocyanate and/or 4,4′-diisocyanate, 1,10-diisocyanatodecane, 1,12-diisocyanatododecane, cyclohexane 1,3- and 1,4-diisocyanate, xylylene diisocyanate isomers, triisocyanatononane (TIN), naphthylene 1,5-diisocyanate, 2,4-diisocyanatotoluene or mixtures thereof with 2,6-diisocyanatotoluene preferably containing, based on mixtures, up to 35% by weight of 2,6-diisocyanatotoluene, 2,2′-, 2,4′-, 4,4′-diisocyanatodiphenylmethane or technical polyisocyanate mixtures of the diphenylmethane series, or any desired mixtures of the polyisocyanates mentioned.

Preference here is given to using aliphatic, cycloaliphatic or araliphatic polyisocyanates selected from the group 1,4-diisocyanatobutane, 1,5-diisocyanatopentane, 1,6-diisocyanatohexane (HDI), 1,5-diisocyanato-2,2-dimethylpentane, 2,2,4- or 2,4,4-trimethyl-1,6-diisocyanatohexane, tetramethyl-xylylene diisocyanate (TMXDI) 1-isocyanato-3,3,5-trimethyl-5-isocyanatomethylcyclohexane (isophorone diisocyanate, IPDI), 1-isocyanato-1-methyl-4 (3)-isocyanatomethylcyclohexane, dicyclohexylmethane 2,4′- and/or 4,4′-diisocyanate, 1,10-diisocyanatodecane, 1,12-diisocyanato-dodecane, cyclohexane 1,3- and 1,4-diisocyanate, xylylene diisocyanate isomers, triisocyanatononane (TIN), or any desired mixtures of such polyisocyanates.

In principle, it is of course also possible to use mixtures of different polyisocyanate components of the type mentioned above.

In addition to the polyaspartic ester-containing component A, the two-component composition of the invention may comprise further components (components C) reactive toward isocyanate groups.

These may, for example, be low-molecular-weight polyols in the molecular weight range from 62 to 300 g/mol, for example ethylene glycol, propylene glycol, trimethylolpropane, glycerol or mixtures of these alcohols, or polyhydroxy compounds having a molecular weight of above 300 g/mol, preferably above 400 g/mol, more preferably between 400 and 8000 g/mol. Such polyhydroxy compounds are in particular those having 2 to 6, preferably 2 to 3, hydroxyl groups per molecule and selected from the group consisting of ether, ester, thioether, carbonate, and polyacrylate polyols and mixtures of such polyols.

In addition, the two-component composition of the invention may contain auxiliaries and additives D.

These include for example inorganic and organic pigments, such as titanium dioxide, zinc oxide, iron oxides, chromium oxides or carbon blacks, and fillers, such as baryte, chalk or talc. A comprehensive review of pigments and fillers for coatings is given in “Lehrbuch der Lacke und Beschichtungen [Textbook on paints and coatings], volume II, “Pigmente, Füllstoffe, Farbstoffe” [Pigments, fillers, dyes], H. Kittel, Verlag W. A. Colomb in der Heenemann GmbH, Berlin-Oberschwandorf, 1974, pp. 17-265.

The auxiliaries and additives D also include catalysts/activators such as titanium-, zirconium-, bismuth-, tin- and/or iron-containing catalysts, as described for example in WO 05058996. It is also possible to add amines or amidines. The proportion of crosslinking catalyst in the composition is by preference ≥0.001% to ≤5% by weight, preferably ≥0.005% to ≤2% by weight, more preferably ≥0.01% to ≤1% by weight, based on the total weight of the two-component composition.

Examples of other suitable auxiliaries and additives D are coatings additives, for instance light stabilizers such as UV absorbers and sterically hindered amines (HALS), and also stabilizers, defoaming agents, anticratering and/or wetting agents, levelling agents, film-forming auxiliaries, reactive diluents, biocides, solvents or substances for rheology control. The use of light stabilizers, especially of UV absorbers, for example substituted benzotriazoles, S-phenyltriazines or oxalanilides, and of sterically hindered amines, especially those having a 2,2,6,6-tetramethylpiperidyl structure—referred to as HALS—is described by way of example in A. Valet, Lichtschutzmittel für Lacke [Light stabilizers for paints], Vincentz Verlag, Hanover, 1996.

Stabilizers, for example free-radical scavengers, and other polymerization inhibitors such as sterically hindered phenols stabilize paint components during storage and are intended to prevent discoloration during curing. Wetting and levelling agents improve surface wetting and/or the levelling of coatings. Examples are fluorosurfactants, silicone surfactants and specific polyacrylates. Rheology-control additives are important in order to control the properties of the two-component system on application and in the levelling phase on the substrate and are disclosed for example in patent specifications WO 9422968, EP0276501, EP0249201 or WO 9712945. It is additionally possible to employ water scavengers, for example triethyl orthoformate, toluenesulfonyl isocyanate, monooxazolidines or molecular sieves, and hydrolysis stabilizers, for example carbodiimides. The proportion of coatings additives in the composition is by preference ≥0.5% to ≤15% by weight, preferably ≥1% to ≤10% by weight, more preferably ≥2% to ≤7% by weight, based on the total weight of the two-component composition. A comprehensive review of coatings additives is given in “Lehrbuch der Lacke und Beschichtungen [Textbook on paints and coatings], volume III, “Lösemittel, Weichmacher, Additive, Zwischenprodukte” [Solvents, plasticizers, additives, intermediates], H. Kittel, Verlag W. A. Colomb in der Heenemann GmbH, Berlin-Oberschwandorf, 1976, pp. 237-398.

Solvents are also regarded as auxiliaries and additives D. The solvent may be an organic solvent or a mixture of organic solvents, or water or a mixture of organic solvent(s) and water. Suitable solvents should be used in a manner known to those skilled in the art, with this use tailored to the composition and to the application process. Solvents are intended to dissolve the components used and promote the mixing thereof, and to avoid incompatibilities. In addition, during application and curing, they should escape from the coating in a manner tailored to the crosslinking reaction in progress so as to afford a solvent-free coating of optimal appearance and free of defects such as popping or pinholes. Suitable solvents include in particular those used in two-component technology. Examples of organic solvents are ketones, such as acetone, methyl ethyl ketone or hexanone, esters, such as ethyl acetate, butyl acetate or methoxypropyl acetate, substituted glycols, and other ethers, aromatics, such as xylene or solvent naphtha, for example from Exxon-Chemie, and mixtures of the solvents mentioned. When the NCO-reactive component of the composition is in the form of an aqueous dispersion, water is also suitable as solvent or diluent. The proportion of solvent in the composition, if present, is by preference ≥0.5% to ≤40% by weight, preferably ≥1% to ≤30% by weight, more preferably ≥2% to ≤25% by weight, based on the total weight of the two-component composition.

In the process of the invention, preference is given to working without solvents.

The ratio of polyisocyanate component B to polyaspartic ester-containing component A in the composition, based on the molar amounts of polyisocyanate groups in relation to NCO-reactive groups, is preferably from 0.5:1.0 to 3.0:1.0. Particular preference is given to a ratio of from 0.9:1.0 to 1.5:1.0. Very particular preference is given to a ratio of from 1.05:1.0 to 1.25:1.0.

The two-component composition of the invention is preferably not a foamable or foam-forming composition. The composition is preferably not polymerizable by free radicals, especially not photopolymerizable, i.e. the composition does not cure through free-radical processes, especially not through free-radical polymerization processes initiated by actinic radiation.

The two-component coating composition of the invention is produced by methods known per se in paint and coatings technology.

An isocyanate-reactive (R) and an isocyanate-containing component (H) are first produced separately by mixing the respective isocyanate-reactive components A and C and by mixing the respective polyisocyanate components B. The auxiliaries and additives D are preferably admixed with the isocyanate-reactive component R. The components R and H thus produced are not mixed together until immediately before or during application. When mixing takes place before application, it should be noted that the reaction of the constituents commences immediately after mixing. The rate of the reaction varies according to the choice of components and additives. The processing time within which the composition must be applied is also known as the pot life and is defined as the time from mixing of the components until doubling of the initial viscosity and/or flow time (determined according to DIN EN ISO 2431:2012-03, but using a DIN 4 flow cup): depending on the choice of components, this is in the range from 1 minute to 24 hours, usually in the range from 10 minutes to 8 hours. The pot life is determined by methods known to those skilled in the art.

The invention also relates to a process for coating a substrate that comprises at least the following steps:
i) applying the two-component coating composition described above to at least part of a substrate to be coated and
ii) curing the coating composition from step i).

The present invention accordingly further provides for the use of the two-component coating compositions of the invention for producing coatings on substrates, the process described above for coating a substrate, and the coated substrates themselves that are obtainable in this way.

The substrates may have already been coated wholly or partly with one or more coating layers. These coating layers may still be uncured or wet, partially cured or fully cured: the further coating layers on the substrate are preferably partially cured or fully cured. Examples of coating layers are priming coats, primers, fillers, spackling coats, basecoats, or substrates that have already been fully painted and are being recoated after possible pretreatment such as sanding or plasma activation.

The two-component coating compositions are used in particular for producing protective coatings in the construction and wind energy sectors. Examples include use for roof coating, for floor coating, and for coating rotor blades in wind turbines and the leading edges thereof.

The present invention accordingly further provides preferably for the use of the two-component coating compositions described above for producing coatings on substrates, the process described above for coating substrates with these coatings, and the coated substrates themselves that are obtainable in this way.

The coating composition may be applied by customary application methods. Examples of application methods are application with a coarse or fine brush, knife application, roller application, and spray application, with preference given to roller application and spray application. Application is followed by an optional curing or drying of the composition of the invention on the substrate or object. This is carried out according to methods that are customary in coating technology, either under ambient conditions (temperature and atmospheric humidity) or under forced conditions, for example by raising the oven temperature, using radiation such as infrared, near-infrared or microwave radiation, and using dehumidified and/or heated air or other gases. This is preferably done without using devices for forced curing. The applied coating composition is for example cured at temperatures of from −20 to 100° C., preferably from −10 to 80° C., more preferably from 0 to 60° C., and most preferably from 10 to 40° C. Although not preferred, lower curing temperatures may also be employed, but will result in longer curing times.

It is likewise possible, although not preferred, to cure the composition at higher temperatures, for example 80 to 160° C. or higher.

After the first coating has cured, a further coating may be applied and likewise cured.

From the two-component coating compositions, coatings are obtainable that have an elongation at break determined according to DIN EN ISO 527 at 23° C. and 50% relative humidity of preferably at least 8.6 MPA, more preferably at least 10 MPA, most preferably at least 15 MPA, and that have a tear propagation resistance determined according to DIN ISO 34-1 at 23° C. and 50% relative humidity of preferably at least 7 N/mm, more preferably at least 10 N/mm, most preferably at least 15 N/mm.

### EXPERIMENTAL SECTION

### Methods

Diethyl fumarate contents were quantified using a GC method with an internal standard. An Agilent 6890 gas chromatograph with a standard GC capillary (100% polysiloxane phase) and FID detector was used. The injector temperature (split outlet) was 180° C. and helium was used as the carrier gas. The quantitation limit of this method was 200 ppm.

All viscosity measurements were carried out using a Physica MCR 51 rheometer from Anton Paar Germany GmbH (Germany) according to DIN EN ISO 3219:1994-10 at 23° C.

Tensile strength and elongation at break were determined according to DIN EN ISO 527.

Tear propagation resistance was determined according to DIN ISO 34-1.

### Reactants

### Polyaspartic Esters

### PAE 1:

Desmophen® NH 1420, commercially available polyaspartic ester from Covestro.

### Material Data:

| | |
|---|---|
| Diethyl fumarate (GC) | 1.62% by weight |

### PAE 2:

Desmophen® NH 1423 LF, commercially available polyaspartic ester from Covestro.

### Material Data:

| | |
|---|---|
| Diethyl fumarate (GC) | 0.05% by weight |

### PAE 3:

Desmophen® NH 1720, commercially available polyaspartic ester from Covestro.

### Material Data:

| | |
|---|---|
| Diethyl fumarate (GC) | 1.02% by weight |

### PAE 4:

Desmophen® NH 1723 LF, commercially available polyaspartic ester from Covestro.

### Material Data:

| | |
|---|---|
| Diethyl fumarate (GC) | 0.04% by weight |

### PAE 5:

Desmophen® NH 1420, commercially available polyaspartic ester from Covestro.

### Material Data:

| | |
|---|---|
| Diethyl fumarate (GC) | 3.5% by weight |

### PAE 6:

Desmophen® NH 1420, commercially available polyaspartic ester from Covestro.

### Material Data:

| | |
|---|---|
| Diethyl fumarate (GC) | 5.5% by weight |

### PAE 7:

Desmophen® NH 1720, commercially available polyaspartic ester from Covestro.

### Material Data:

| | |
|---|---|
| Diethyl fumarate (GC) | 3.5% by weight |

### PAE 8:

Desmophen® NH 1720, commercially available polyaspartic ester from Covestro.

### Material Data:

| | |
|---|---|
| Diethyl fumarate (GC) | 5.5% by weight |

The different diethyl fumarate contents in PAE 1, 5, and 6 and in PAE 3, 7, and 8 are due to different degrees of maturation.

### Polyisocyanates:

Desmodur® N3900, commercially available polyisocyanate from Covestro.

### Material Data:

| | |
|---|---|
| NCO content | approx. 23.5% by weight |

Desmodur® E 30700, commercially available polyisocyanate from Covestro.

### Material Data:

| | |
|---|---|
| NCO content | approx. 11% by weight |

### Production of Coatings

The coatings were produced at room temperature by introducing the constituents of component A and component B into a cup (Speedmixer cup) and homogenizing them at approx. 2100 rpm for approx. 30 sec.

### Layer Construction

The coatings employed were applied to a polypropylene plate by the described application method and crosslinked at 23° C. and 50% relative humidity. For the tests, coatings approx. 1 mm thick were produced by pouring. The coatings were first stored at room temperature for one day and then stored at 50° C. for 3 days. After storage, the test specimens were produced using a punch.

TABLE 1
Composition of the coatings

| | Example 1 | Example 2 | Example 5 | Example 6 | Example 3 | Example 4 | Example 7 | Example 8 |
|---|---|---|---|---|---|---|---|---|
| | Inventive | | Comparative | | Inventive | | Comparative | |
| Component A (wt %) | | | | | | | | |
| Desmophen ® NH 1420, | | 23.39 | | | | 32.55 | | |
| DEF 1.62% by weight | | | | | | | | |
| Desmophen ® NH 1423 | 23.17 | | | | 32.24 | | | |
| LF, DEF 0.05% by weight | | | | | | | | |
| Desmophen ® NH 1720, | | 23.39 | | | | 13.95 | | |
| DEF 1.02% by weight | | | | | | | | |
| Desmophen ® NH 1723 | 23.17 | | | | 13.82 | | | |
| LF, DEF 0.04% by weight | | | | | | | | |
| Desmophen ® NH 1420, | | | 23.39 | | | | 32.55 | |
| DEF 3.5% by weight | | | | | | | | |
| Desmophen ® NH 1420, | | | | 23.39 | | | | 32.55 |
| DEF 5.5% by weight | | | | | | | | |
| Desmophen ® NH 1720, | | | 23.39 | | | | 13.95 | |
| DEF 3.5% by weight | | | | | | | | |
| Desmophen ® NH 1720, | | | | 23.39 | | | | 13.95 |
| DEF 5.5% by weight | | | | | | | | |
| Diethyl fumarate content | 0.05 | 1.32 | 3.50 | 5.50 | 0.05 | 1.44 | 3.50 | 5.50 |
| based on total weight of | | | | | | | | |
| component A. | | | | | | | | |
| Mixing ratio of | 1:1 | | | | 7:3 | | | |
| NH 14xx:NH 17xx | | | | | | | | |
| Component B (wt %) | | | | | | | | |
| Desmodur ® N 3900 | 13.42 | 13.31 | 13.31 | 13.31 | 13.49 | 13.38 | 13.38 | 13.38 |
| Desmodur ® E 30700 | 40.25 | 39.92 | 39.92 | 39.92 | 40.46 | 40.13 | 40.13 | 40.13 |
| Total weight | 100.0 | 100.0 | 100.0 | 100.0 | 100.0 | 100.0 | 100.0 | 100.0 |

DEF = diethyl fumarate content

TABLE 2
Mechanical properties of the coatings from examples 1 to 8.

| | | | | | | | |
|---|---|---|---|---|---|---|---|
| Example 1 | Example 2 | Example 5 | Example 6 | Example 3 | Example 4 | Example 7 | Example 8 |

| | | | |
|---|---|---|---|
| Inventive | Comparative | Inventive | Comparative |

Tensile strength
23° C./50% rel.
humidity

| Elongation at break | 12.1 | MPa | 8.8 | MPa | 2.7 | MPa | 2.2 | MPa | 16.6 | MPa | 10.2 | MPa | 8.4 | MPa | 3.8 | MPa |
|---|---|---|---|---|---|---|---|---|---|---|---|---|---|---|---|---|
| Tear resistance | | | | | | | | | | | | | | | | |
| 23° C./50% rel. | | | | | | | | | | | | | | | | |
| humidity | | | | | | | | | | | | | | | | |
| Tear propagation | 10.9 | N/mm | 7.5 | N/mm | 4.8 | N/mm | 2.9 | N/mm | 20.1 | N/mm | 10.9 | N/mm | 9.7 | N/mm | 6.4 | N/mm |

resistance

As can be seen from Table 2, coatings obtained from coating compositions of the invention having a diethyl fumarate content of ≤1.5% by weight have markedly higher tensile strength (examples 1 to 4), and in some cases also markedly higher tear resistance (examples 1, 3, and 4), than coatings produced on the basis of conventional polyaspartic esters (examples 5 to 8).

1. A two-component coating composition comprising:
a) at least one polyaspartic ester-containing component A,
b) at least one polyisocyanate component B,
c) optionally one or more components C that are different from A and are reactive toward isocyanate groups, and
d) optionally auxiliaries and additives D,
wherein component A corresponds to compositions comprising
A1) one or more polyaspartic esters of the general formula (I) 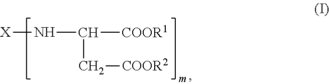
in which
X is an m-valent organic radical,
R¹ and R² are identical or different organic radicals each having 1 to 18 carbon atoms,
m is an integer >1,
and
optionally one or more polyaspartic esters having a primary amino group that are of the general formula (II) 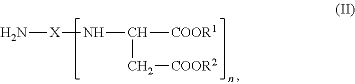
in which
n is m-1 and
m, X, and the radicals R¹ and R² are as defined above,
and
A2) one or more polyaspartic esters of the general formula (III) 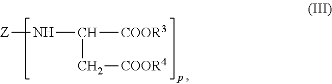
in which
Z is a p-valent organic radical,
R³ and R⁴ are identical or different organic radicals each having 1 to 18 carbon atoms,
p is an integer >1,
wherein component A2 is present in a proportion of from ≥1% to ≤80% by weight based on the total weight of components A1 and A2, and
wherein dialkyl fumarates are present in component A in an amount of from ≥0.02% to ≤0.75% by weight, determined according to the method specified in the specification and based on the total weight of component A.

2. The two-component coating composition as claimed in claim 1, wherein component A2 is present in a proportion of from ≥10% to ≤80% by weight based on the total weight of components A1 and A2.

3. The two-component coating composition as claimed in claim 1, wherein component A2 is present in a proportion of from ≥25% to ≤55% by weight based on the total weight of components A1 and A2.

4. The two-component coating composition as claimed in claim 1, wherein dialkyl fumarates are present in component A in an amount of from ≥0.02% to ≤0.27% by weight, determined according to the method specified in the specification and based on the total weight of component A.

5. The two-component coating composition as claimed in claim 1, wherein dialkyl fumarates are present in component A in an amount of from ≥0.02% to ≤0.25% by weight, determined according to the method specified in the specification and based on the total weight of component A.

6. A process for producing a coating on a substrate comprising at least the following steps:
i) applying a two-component coating composition of claim 1 to at least part of a substrate to be coated and
ii) curing the coating composition from step i).

7. A substrate coated with the two-component coating composition of claim 1.

8. The substrate of claim 7, wherein the substrate is a roof, a floor or a rotor blade.

9. The two-component coating composition of claim 1, wherein X of component A1 contains one or more heteroatoms, and is in the molecular weight range from 60 to 6000 g/mol.

10. The two-component coating composition of claim 1, wherein m of component A1 is 2.

11. The two-component coating composition of claim 1, wherein Z of component A2 contains one or more heteroatoms, and is in the molecular weight range from 200 to 2000 g/mol.

12. The two-component coating composition of claim 1, wherein p of component A2 is 2 or 3.
